(19) United States
(12) Patent Application Publication
(10) Pub. No.: US 2015/0306742 A1
(43) Pub. Date: Oct. 29, 2015

(54) Clamping Mechanism For Automotive Check Fixture

(71) Applicant: Anthony Amrecki, Sterling Heights, MI (US)

(72) Inventor: Anthony Amrecki, Sterling Heights, MI (US)

(21) Appl. No.: 14/261,450

(22) Filed: Apr. 25, 2014

(51) Int. Cl. B25B 5/08; B25B 5/06

(52) U.S. Cl. CPC B25B 5/087; B25B 5/064

(57) ABSTRACT

The invention is directed toward an improved clamp for an automotive checking fixture. The clamp comprises a body, a cap, a plunger pin, a hard stop dowel, a plurality of fingers, a plurality of engagement jaws, an alignment strap, a plurality of pivot pins, a plurality of alignment pins, a plurality of springs, and a plurality of set screws. Furthermore the body may further comprise an internal compartment, a plurality of mounting holes, a plurality of set screw channels, and a plurality of locating holes. The mounting holes permit the body to be mounted to a checking fixture. The locating holes permit the cap to be aligned properly to the body. The set screw holes receive the set screws. Furthermore, the engagement jaws have a plurality of holes for attaching the engagement jaws to the fingers. The engagement jaws may have a shaped edge to create an opening.

### TECHNICAL FIELD

The invention pertains generally to automotive check fixtures and more specifically to an improved clamping mechanism for an automotive check fixture.

### BACKGROUND OF THE INVENTION

The automotive industry is a highly technical field. Cars are constructed from many parts which are required to be a specific size and shape. Many internal components are made of metal or plastic. These internal components, such as a dashboard, door, or seat, are normally constructed with location pins and mounting clips that permit two opposing pieces to fit together. These internal components must be a specific size and shape to be connected together. During the manufacturing process a part will be clamped in place on a fixture so that a technician can check the quality of the automotive component. A technician checks the shape of the automotive component and can test the component for thickness, tolerance, or any other desired attribute. The fixture on which the automotive component is placed is commonly referred to a checking fixture.

Clamps on current check fixtures are limited in use. Current clamps must be placed in an exact position and location. Through repeated use clamps may become askew or misaligned. This presents a problem as components then may not fit properly on the checking fixture. Additionally, components may be damaged if a clamp engages the component incorrectly. If a clamp becomes ineffective it is often difficult to fix the problem without dismantling the entire checking fixture or removing the entire clamp. What is needed is a clamp for a checking fixture that can be easily manipulated or fixed in the event of an issue. The current invention permits a user to customize the position of the clamps within the clamping mechanism so that if a clamp becomes misaligned it is easy to correct the problem without replacing the clamp or dismantling the clamping fixture. The invention is an improvement over current clamps which do not permit a user to customize the position or alignment of the clamping fingers.

In addition, current clamps may naturally apply too much pressure to a component when securing it to the checking fixture. Clamps are normally manufactured without any special shape or structure to account for utilization on a specific automotive component. Therefore, a mechanism is needed to prevent clamps from naturally exerting too much pressure on an automotive component. The invention is an improvement over current clamps as the invention utilizes a dowel in the clamping mechanism to prevent the fingers from clamping with too much pressure.

### SUMMARY OF THE INVENTION

The invention is directed toward an improved clamp for an automotive checking fixture. The clamp comprises a body, a cap, a plunger pin, a pivot stop dowel, a plurality of fingers, a plurality of engagement jaws, an alignment strap, a plurality of pivot dowel pins, a plurality of alignment pins, a plurality of springs, and a plurality of set screws. The invention may further comprise two fingers, two engagement jaws, two pivot dowel pins, two alignment pins, two set screws, and two springs. Furthermore the body may further comprise an internal compartment, a plurality of mounting holes, a plurality of set screw holes, and a plurality of locating holes. The mounting holes permit the body to be mounted to a checking fixture. The set screw holes receive the set screws. The locating holes permit the cap to be aligned to the body and also locates the body to the fixture. In one embodiment the body further comprises four mounting holes, two set screw holes, and two locating holes. Furthermore, the engagement jaws may have a plurality of holes for attaching the engagement jaws to the fingers. Additionally, the engagement jaws may have a shaped edge to create an opening.

In another embodiment of the invention each of the fingers further comprise an upper extension, a pivot dowel pin hole, an alignment pin hole, a plunger pin gap, a set screw receiver, and a spring receiver. The upper extension protrudes past the body. The engagement jaws are removably secured to the upper extensions. The pivot dowel pin hole houses a pivot dowel pin. The finger may pivot about the pivot dowel pin. The alignment pin hole houses an alignment pin. The plunger pin gap receives the tip of the plunger pin. The plunger pin pushes the bottom of the fingers away from each other, causing the fingers to pivot about the pivot dowel pins, placing the fingers into correct alignment. The purpose of the set screw is to align the fingers in conjunction with the alignment strap that keeps the fingers parallel. The set screw may protrude from the set screw channel into the set screw receiver. The spring receiver houses the spring.

In another embodiment of the clamp the alignment pins may extend through the alignment pin holes of the fingers and protrude into the alignment strap. The pivot dowel pins extend through the pivot dowel pin holes of the fingers. Additionally, the pivot stop dowel is secured to the body and extends through the inner compartment of the body between the fingers.

In another embodiment of the invention the plunger pin is inserted into the body the plunger pin engages the fingers at the plunger pin gaps. The plunger pin pushes the lower ends of the fingers apart and compresses the springs into the spring receivers. The lower ends of the fingers are pushed apart, the fingers pivot about the pivot dowel pins and the upper ends of the fingers move together. The upper ends of the fingers move together until the fingers engage the pivot stop dowel. The engagement jaws engage a clip on an automotive component when the upper ends of the fingers move together.

The components of invention may be made out of any material. Preferably, the components are constructed out of metal such as aluminum, steel, or hard steel. In one embodiment, the body and cap are constructed out of aluminum, the plunger pin, the fingers, the engagement jaws, and the alignment strap are constructed out of steel, and the pivot stop dowel is constructed out of hard steel. The clamp may be any size when constructed together. In one embodiment of the invention the body is substantially 7.62 cm high by 4.5 cm wide by 3.5 cm deep, the cap is substantially 7.62 cm high by 4.5 cm wide by 0.9 cm deep, each of the fingers is substantially 5.08 cm tall by 0.79 cm wide by 2.5 cm deep, each of the engagement jaws is substantially 2.5 cm high by 1.27 cm wide by 0.3 cm deep, the alignment strap is substantially 0.8 cm high by 2.5 cm wide by 0.318 cm deep, and the plunger pin is substantially 9.0 cm in length.

The plunger pin may be operated in any physical manner, including manually or through the use of an air cylinder or by pulling a cable. If operated manually the clamp further comprises a knob attached to the plunger pin. Alternatively, the clamp may further comprise a cam clamp. The cam is attached to the plunger pin. The rotation of the cam causes the plunger pin to extend into and out of the inner compartment of the body. Alternatively, the clamp further comprises a wire cable and a lever. The wire cable is within a wire cable housing. The wire cable has two ends. One end of the wire cable is attached to the plunger pin and the other end of the wire cable is attached to the lever. The movement of the lever causes the wire cable to move longitudinally through the wire cable housing. The longitudinal movement of the wire cable causes the plunger pin to extend into and out of the inner compartment of the body. Alternatively, the clamp may further comprise a piston and an electronic control unit. The piston is connected to the plunger pin. The electronic control unit controls the operation of the piston.

In one embodiment of the invention the invention comprises a body, a cap, a plunger pin, a pivot stop dowel, a plurality of fingers, a plurality of engagement jaws, an alignment strap, a plurality of pivot dowel pins, a plurality of alignment pins, a plurality of springs, and a plurality of set screws. In this embodiment each of the fingers comprise an upper extension, a pivot dowel pin hole, an alignment pin hole, a plunger pin gap, a set screw receiver, and a spring receiver. The upper extension protrudes past the body. The engagement jaws are removably secured to the upper extensions. The pivot dowel pin hole houses a pivot dowel pin. The finger may pivot about the pivot dowel pin. The alignment pin hole houses an alignment pin. The plunger pin gap receives the tip of the plunger pin. A person may screw the set screw until the set screw protrudes from the set screw hole into the set screw receiver. The spring receiver houses the spring.

### BRIEF DESCRIPTION OF THE DRAWINGS

FIG. 1 is a view of the clamping mechanism.

FIG. 2 is a view of the clamping mechanism without its cover.

FIG. 3 is an exploded view of the clamping mechanism.

FIG. 4 is a view of the clamping mechanism with the fingers closed.

FIG. 5 is a view of the clamping mechanism with the fingers open.

FIG. 6 is a top view of the engagement jaws.

FIG. 7 is a side and edge view of a finger.

### DETAILED DESCRIPTION OF THE DRAWINGS

The claimed subject matter is now described with reference to the drawings. In the following description, for purposes of explanation, numerous specific details are set forth in order to provide a thorough understanding of the claimed subject matter. It may be evident, however, that the claimed subject matter may be practiced with or without any combination of these specific details, without departing from the spirit and scope of this invention and the claims.

The following description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

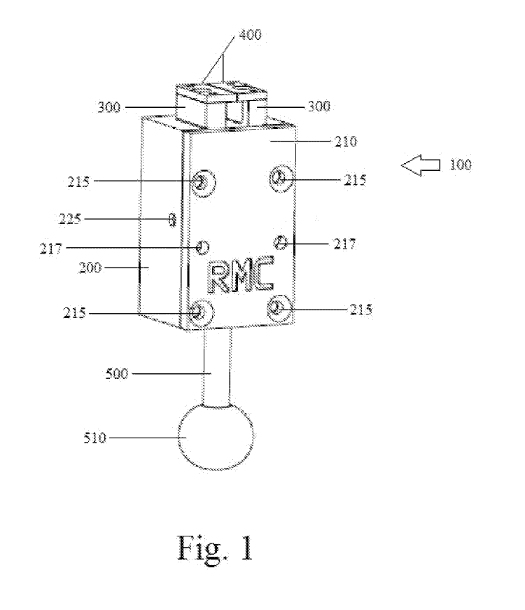

FIG. 1 displays an external view of one embodiment of the clamping mechanism 100. The clamping mechanism 100 comprises a body 200, a cap 210, a plurality of fingers 300, a plurality of engagement jaws 400, a plunger pin 500, and a knob 510. The body 200 and cap 210 contain a plurality of mounting holes 215 and a plurality of locating holes 217. The body 200 also has a plurality of set screw holes 225.

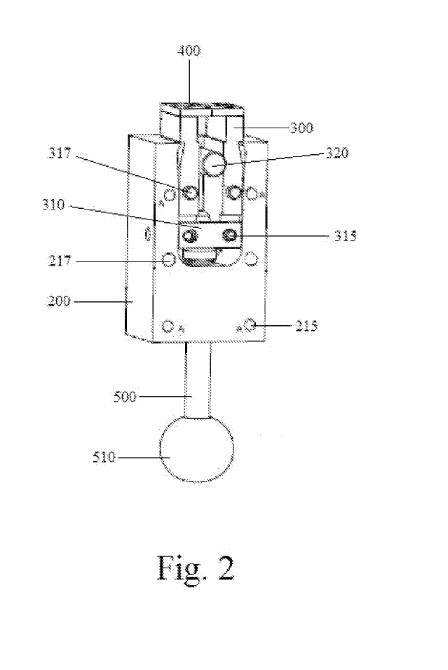

FIG. 2 displays a view of the clamping mechanism 100 with the cap 210 removed displaying the internal structure of the clamping mechanism 100. Within the internal structure are a pivot stop dowel 320, an alignment strap 310, a plurality of pivot dowel pins 317, and a plurality of alignment pins 315.

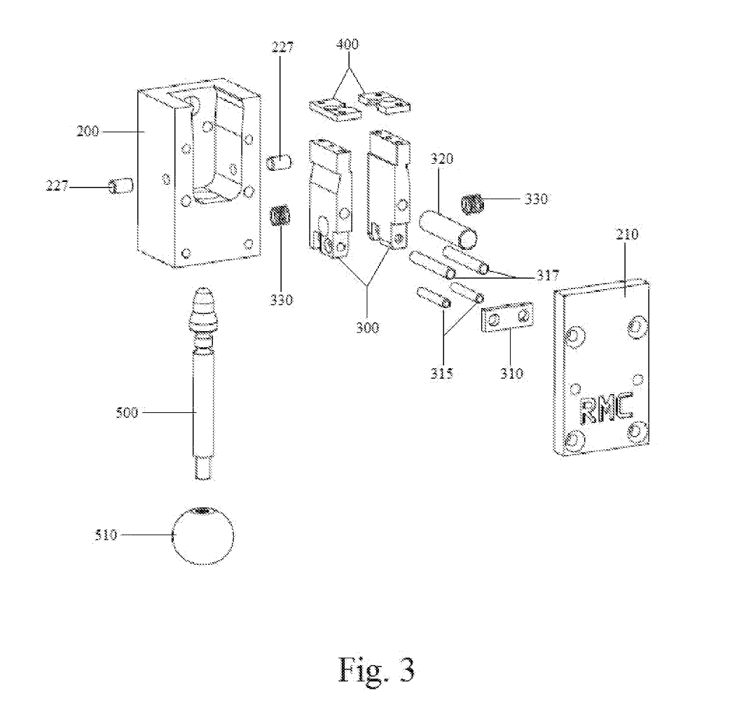

FIG. 3 displays an exploded view of the clamping mechanism 100. The clamping mechanism 100 comprises a body 200, a cap 210, a plunger pin 500, a knob 510, a plurality of set screws 227, a plurality of springs 330, a plurality of fingers 300, a plurality of engagement caps 400, a pivot stop dowel 320, a plurality of pivot dowel pins 317, a plurality of alignment pins 315, and an alignment strap 310.

Referring generally to FIG. 1 through FIG. 3, the structure of the clamping mechanism will be described. The primary component of the clamping mechanism 100 is the body 200 which houses the majority of the components. The body 200 has an internal void for housing the components of the mechanism. The body 200 attaches with a cap 210 which encloses the components within the body 200. Within the body 200 are two fingers 300. Each of the fingers 300 pivot about a pivot dowel pin 317. Attached at the top of each finger 300 is an engagement jaw 400. Between the two fingers is a pivot stop dowel 320 which ensures proper spacing between the fingers 300. The pivot stop dowel 320 also prevents the fingers from closing together too closely and thus clamping too hard on an automotive component. Through the bottom of each of the fingers 300 passes an alignment pin 315. Each alignment pin 315 is attached to an alignment strap 310. The alignment strap 310 connects the two fingers 300 loosely together at the bottom to maintain proper alignment between the fingers 300. The fingers 300 may be moved laterally closer to each other or further away from each other. The clamping mechanism 100 has two set screws 227 inserted laterally into the body 200 through two set screw holes 225. In the preferred embodiment the set screw holes 227 are threaded to complement the threading of the set screws 227. The set screws 227 may be screwed in toward the inner compartment of the body 200 to position the fingers 300 closer together. The set screws 227 may be screwed outward away from the inner compartment of the body 200 to position the fingers 300 further apart. Within the inner compartment of the body 200 are two springs 330. Each spring 330 is positioned laterally from a finger 300 between the finger 300 and the edge of the inner compartment of the body 200. Each spring 330 is positioned beneath the pivot dowel pin 317 such that as the spring 330 pushes the lower end of the finger 300 the finger pivots about the pivot dowel pin 317 and the upper ends of the fingers 300 move apart.

The plunger pin 500 is inserted through the lower section of the body 200. The plunger pin 500 has a knob 510 located on the distal end of the plunger pin 500. The tip of plunger pin 500 is inserted between the fingers 300. The knob 510 on the plunger pin 500 permits a user to push the plunger pin 500 further into the inner compartment of the body 200 or pull the plunger pin 500 out from the inner compartment of the body 200. As the plunger pin 500 is pushed further into the inner compartment of the body 200, the plunger pin 500 is positioned between the two fingers 300.

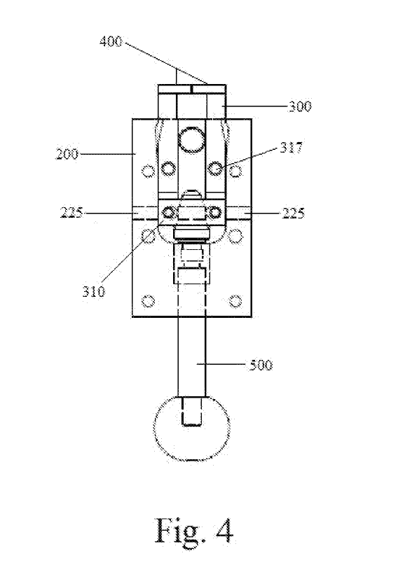

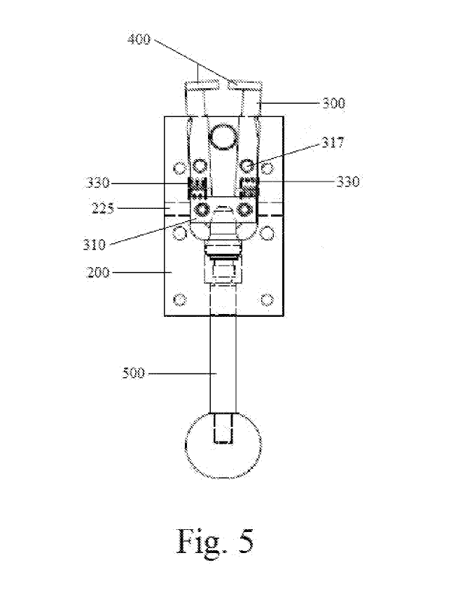

Referring to FIG. 4 and FIG. 5, the utilization of the clamping mechanism 100 is displayed. As the plunger pin 500 is inserted into the inner compartment of the body 200, the tip of the plunger pin 500 moves between the fingers 300 at the lower end of the fingers 300. The lower ends of the fingers 300 are pushed apart, compressing the springs 330. The fingers 300 pivot around the pivot dowel pins 317 and the upper ends of the fingers 300 move toward each other. As the upper ends of the fingers 300 move toward each other the upper ends of the fingers 300 move until they engage the pivot stop dowel 320. As the upper ends of the fingers 300 move together the engagement jaws 400 compress together to engage a clip on an automotive component. As the lower ends of the fingers move apart the alignment pins 315 move within the alignment strap 310. The holes that the alignment pins 315 move through are oblong in shape to permit the alignment pins to slide laterally along the alignment strap 310. The alignment strap 310 permits the alignment pins 315 to move laterally until the fingers 300 are in proper alignment.

As the plunger pin 500 is withdrawn from the inner compartment of the body 200, the springs 330 push on the lower ends of the fingers 300. The lower ends of the fingers 300 are pushed closer together. The fingers 300 pivot about the pivot dowel pins 317 such that the upper ends of the fingers 300 move apart. As the upper ends of the fingers 300 move apart the engagement jaws 400 move apart and release the clip of the automotive component.

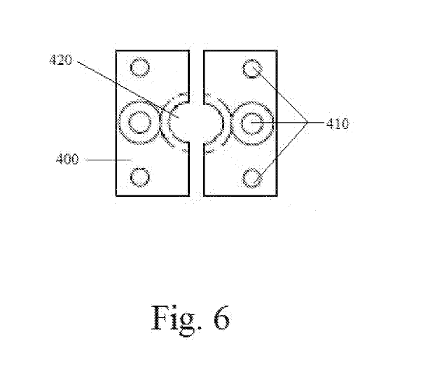

FIG. 6 displays the engagement jaws 400. The two engagement jaws 400 have a plurality of holes 410 for attaching the engagement jaws 400 to the fingers 300. The engagement jaws 400 have a shaped inner edge to create an opening 420. The opening 420 may be any shape which can engage the clip of an automotive component. In the embodiment displayed, the opening 420 is circular. The opening 420 may also be a square, triangle, rectangle, oval, or any other shape. In the preferred embodiment the engagement jaws 400 have straight edges, permitting a user to machine a customized shape in the engagement jaws 400 and create a unique, customized shape for the opening 420.

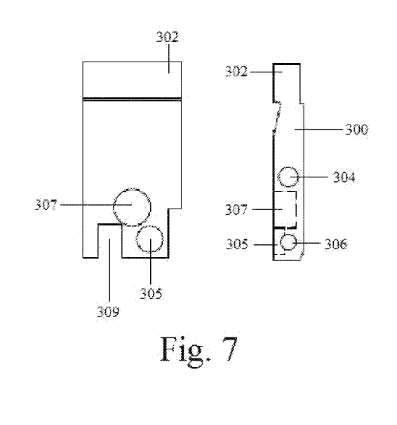

FIG. 7 displays a finger 300 from the edge and the side. The fingers 300 may be any shape so long as the fingers 300 pivot about the pivot dowel pins 317 and have extensions permitting engagement jaws to be secured to the fingers 300. The finger 300 has an upper extension 302 which extends beyond the body 200 and to which an engagement jaw 400 may be removably secured. The finger has a pivot dowel pin hole 304 located approximately in the center of the finger 300. The finger has an alignment pin hole 306 at the bottom end of the finger 300 into which an alignment pin 315 may be placed. In the bottom edge of the finger 300 is a plunger gap 309 into which the tip of the plunger pin 500 may be placed. Into the side of the finger 300 are two depressions. A set screw receiver 307 is a circular hole into which a set screw 227 is inserted to allow a user to customize the lateral position of the finger 300. Additionally, a spring receiver 305 is a circular hole into which a spring 330 is inserted and compressed to apply a constant lateral force onto the lower end of the finger 300. Due to the force from the spring 330, the default position of the fingers 300 is an open position where the engagement jaws 400 are apart and a user may insert a clip from an automotive component.

The clamping mechanism 100 may be utilized in any manner or embodiment sufficient to engage and hold a clip of an automotive component. In another embodiment the plunger pin 500 may be driven by a hydraulic or pneumatic system. In this embodiment the user would engage a lever to assert a hydraulic or pneumatic force through a tube which would cause the plunger pin 500 to insert into the body 200. The user would then disengage the lever to release the hydraulic or pneumatic force. The plunger pin 500 would then be withdrawn from the body 200. Such a system may further utilize an electric controller, permitting the user to engage or disengage the hydraulic or pneumatic system with the simple push of a button.

The knob 510 on the plunger pin may also be replaced with a mechanical wire cable system. The wire is cable is housed within a wire cable housing. One end of the wire cable is connected to a lever and the other end of the wire cable is connected to the plunger pin 500. As a user moves the lever back and forth, the wire cable slides within the wire cable housing to move the plunger pin 500 into and out of the inner compartment of the body 200. In another embodiment the plunger pin 500 is attached to a cam attached to the outside of the body 200. As the cam is turned the plunger pin 500 is inserted further into the inner compartment of the body 200. As the cam is then returned to the original position the plunger pin 500 is withdrawn from the inner compartment of the body 200.

1. An improved clamp for an automotive checking fixture comprising
a body
a cap
a plunger pin
a pivot stop dowel
a plurality of fingers
a plurality of engagement jaws
an alignment strap
a plurality of pivot dowel pins
a plurality of alignment pins
a plurality of springs
a plurality of set screws.

2. The clamp as in claim 1 further comprising
two fingers
two engagement jaws
two pivot dowel pins
two alignment pins
two set screws
two springs.

3. The clamp as in claim 2 wherein said body further comprises
an internal compartment
a plurality of mounting holes
wherein said mounting holes permit said body to be mounted to a checking fixture.
a plurality of set screw holes
wherein said set screw holes receive said set screws
a plurality of locating holes
wherein said locating holes permit said cap to be attached to said body.

4. The clamp as in claim 3 wherein said body further comprises
four mounting holes
two set screw holes
two locating holes.

5. The clamp as in claim 4 wherein said engagement jaws have a plurality of holes for attaching said engagement jaws to said fingers.

6. The clamp as in claim 5 wherein said engagement jaws have a shaped edge to create an opening.

7. The clamp as in claim 6 wherein each of said fingers further comprise
an upper extension, said upper extension protruding past said body
wherein said engagement jaws are removably secured to said upper extensions
a pivot dowel pin channel
wherein said pivot dowel pin channel houses a pivot dowel pin
wherein said finger may pivot about said pivot dowel pin
an alignment pin channel
wherein said alignment pin channel houses an alignment pin
a plunger pin gap
wherein said plunger pin gap receives the tip of said plunger pin
a set screw receiver
wherein a person may screw said set screw until said set screw protrudes from said set screw channel into said set screw receiver
a spring receiver
wherein said spring receiver houses said spring.

8. The clamp as in claim 7
wherein said alignment pins extend through said alignment pin holes of said fingers and protrude into said alignment strap
wherein said pivot dowel pins extend through said pivot dowel pin holes of said fingers
wherein said pivot stop dowel is secured to said body and extends through said inner compartment of said body between said fingers.

9. The clamp as in claim 8
wherein as said plunger pin is inserted into said body said plunger pin engages said fingers at said plunger pin gaps
wherein said plunger pin pushes the lower ends of said fingers apart and compresses said springs into said spring receivers
wherein as said lower ends of said fingers are pushed apart, said fingers pivot about said pivot dowel pins and said upper ends of said fingers move together
wherein said upper ends of said fingers move together until said fingers engage said pivot stop dowel
wherein said engagement jaws engage a clip on an automotive component when said upper ends of said fingers move together.

10. The clamp as in claim 9
wherein said body is substantially 7.62 cm high by 4.5 cm wide by 3.5 cm deep
wherein said cap is substantially 7.62 cm high by 4.5 cm wide by 0.9 cm deep
wherein each of said fingers is substantially 5.08 cm tall by 0.79 cm wide by 2.5 cm deep
wherein each of said engagement jaws is substantially 2.5 cm high by 1.27 cm wide by 0.3 cm deep
wherein said alignment strap is substantially 0.8 cm high by 2.5 cm wide by 0.318 cm deep
wherein said plunger pin is substantially 9.0 cm in length.

11. The clamp as in claim 10
wherein said body and said cap are constructed of aluminum
wherein said plunger pin, said fingers, said engagement jaws, and said alignment strap are constructed of steel
wherein said pivot stop dowel is constructed of hard steel.

12. The clamp as in claim 11 further comprising a knob attached to said plunger pin.

13. The clamp as in claim 11 further comprising a cam
wherein said cam is attached to said plunger pin
wherein the rotation of said cam causes said plunger pin to extend into and out of said inner compartment of said body.

14. The clamp as in claim 11 further comprising a wire cable and a lever
wherein said wire cable is within a wire cable housing
wherein said wire cable has two ends, wherein one end of said wire cable is attached to said plunger pin, wherein the other end of said wire cable is attached to a lever
wherein the movement of said lever causes said wire cable to move longitudinally through said wire cable housing
wherein said longitudinal movement of said wire cable causes said plunger pin to extend into and out of said inner compartment of said body.

15. The clamp as in claim 11 further comprising
a piston
an electronic control unit
wherein said piston is connected to said plunger pin
wherein said electronic control unit controls the operation of said piston.

16. The clamp as in claim 1 further comprising a knob attached to said plunger pin.

17. The clamp as in claim 1 further comprising a cam
wherein said cam is attached to said plunger pin
wherein the rotation of said cam causes said plunger pin to extend into and out of said inner compartment of said body.

18. The clamp as in claim 1 further comprising a wire cable and a lever
wherein said wire cable is within a wire cable housing
wherein said wire cable has two ends, wherein one end of said wire cable is attached to said plunger pin, wherein the other end of said wire cable is attached to a lever
wherein the movement of said lever causes said wire cable to move longitudinally through said wire cable housing
wherein said longitudinal movement of said wire cable causes said plunger pin to extend into and out of said inner compartment of said body.

19. The clamp as in claim 1 further comprising
a piston
an electronic control unit
wherein said piston is connected to said plunger pin
wherein said electronic control unit controls the operation of said piston.

20. The clamp as in claim 1 wherein each of said fingers further comprise
an upper extension, said upper extension protruding past said body
wherein said engagement jaws are removably secured to said upper extensions
a pivot dowel pin channel
wherein said pivot dowel pin channel houses a pivot dowel pin
wherein said finger may pivot about said pivot dowel pin
an alignment pin channel
wherein said alignment pin channel houses an alignment pin a plunger pin gap
wherein said plunger pin gap receives the tip of said plunger pin
a set screw receiver
wherein a person may screw said set screw until said set screw protrudes from said set screw channel into said set screw receiver
a spring receiver
wherein said spring receiver houses said spring.
